(19) United States
(12) Patent Application Publication
(10) Pub. No.: US 2024/0209940 A1
(43) Pub. Date: Jun. 27, 2024

(54) LOCKING UNIT WITH A MULTIDIRECTIONAL HALL SENSOR, AND SENSOR UNIT

(71) Applicant: SVM Schultz Verwaltungs-GmbH & Co. KG, Memmingen (DE)

(72) Inventors: Ralf Raupold, Sontheim (DE); Florian Hölzle, Illertissen (DE); Ralph Wassermann, Holzgünz (DE)

(21) Appl. No.: 18/391,751

(22) Filed: Dec. 21, 2023

(30) Foreign Application Priority Data
Dec. 22, 2022 (DE) 102022134624.2

(51) Int. Cl. F16H 63/34; G01D 5/14

(52) U.S. Cl. CPC F16H 63/3475; F16H 63/3483; G01D 5/145

(57) ABSTRACT

A locking unit having a housing, a piston, a solenoid, a latching element, a guide element, and a sensor unit, wherein the sensor unit comprises a permanent magnet, a multidirectional Hall sensor for detecting a magnetic field of the permanent magnet, and a magnetic field changing means comprises a plurality of changing elements. One of either the permanent magnet or the multidirectional Hall sensor is arranged in a fixed position, wherein the respective other of the permanent magnet and multidirectional Hall sensor is adjustable along a first movement path, wherein the magnetic field changing means is adjustable along a second movement path in an intermediate space of the permanent magnet and multidirectional Hall sensor, wherein the plurality of changing elements defines at least two regions of different magnetic permeability in the intermediate space.

### CROSS-REFERENCE TO RELATED APPLICATIONS

This non-provisional application claims the benefit of, and priority to, German Application No. 102022134624.2, entitled Locking Unit with a Multidirectional Hall Sensor, and Sensor Unit, filed on Dec. 22, 2022, which is incorporated by reference in its entirety.

### FIELD OF THE DISCLOSURE

The invention relates to a locking unit and to a sensor unit, and more particularly, to a locking unit and a sensor unit for an automatic transmission of a vehicle.

### BACKGROUND

Locking units are used, for example, for automatic transmissions of motor vehicles that are locked in a parked state. Locking units of this type are typically designed in such a manner that the parking lock is in different states or is locked or is not locked, depending on the switching position. For this purpose, use can be made, for example, of a piston which can be moved in particular hydraulically and can be locked electromechanically.

In order to sense switching positions of a component, known locking units can in each case comprise a sensor provided for this purpose. Therefore, each component to be sensed requires at least one separate sensor.

### SUMMARY

It is therefore an object of the invention to design a locking unit alternatively or better. In addition, the intention is to propose a suitable general sensor unit.

In some aspects, the locking unit includes: a housing through which a longitudinal axis passes; a piston which is adjustable along the longitudinal axis between a retracted retraction position and an extended extension position, wherein the locking unit serves for locking a movement of the piston, which can be acted upon with a pressure of a fluid, wherein the piston has a first latching receptacle and a second latching receptacle; a solenoid having an armature and an armature rod connected to the armature; at least one latching element, wherein the piston is fixed by retaining interaction of the at least one latching element with one of the first latching receptacle and the second latching receptacle of the piston; a guide element fixedly connected to the armature or to the armature rod of the solenoid, wherein the guide element is adjustable along the longitudinal axis of the housing between a blocking position and a release position, wherein, depending on the position, the guide element pushes the at least one latching element radially outward; and a sensor unit including a permanent magnet, a multidirectional Hall sensor for detecting a magnetic field of the permanent magnet and a magnetic field changing means, wherein one of either the permanent magnet or the multidirectional Hall sensor is arranged in a fixed position with respect to the housing and the respective other of the permanent magnet and multidirectional Hall sensor is connected to the guide element so as to be adjustable along the longitudinal axis, wherein the piston penetrates an intermediate space between the permanent magnet and multidirectional Hall sensor, wherein a region of the piston, which is adjustable through the intermediate space radially adjacently along the positionally fixed element of the permanent magnet and multidirectional Hall sensor, defines a detection range, wherein the magnetic field changing means is arranged fixedly on the piston in the detection range such that different magnetic permeabilities are formed along the longitudinal axis in the detection range.

In some aspects, the sensor unit includes: a permanent magnet; a multidirectional Hall sensor for detecting a magnetic field of the permanent magnet; and a magnetic field changing means includes a plurality of changing elements, wherein one of either the permanent magnet or the multidirectional Hall sensor is arranged in a fixed position, wherein the respective other of the permanent magnet and multidirectional Hall sensor is adjustable along a first movement path, wherein the magnetic field changing means is adjustable along a second movement path in an intermediate space of the permanent magnet and multidirectional Hall sensor, wherein the plurality of changing elements defines at least two regions of different magnetic permeability in the intermediate space.

### BRIEF DESCRIPTION OF THE DRAWINGS

Further features, details and advantages of the invention emerge from the wording of the claims and from the following description of exemplary embodiments on the basis of the drawings. In the figures:

FIG. 1 shows a longitudinal sectional view of a locking unit according to a first embodiment;

FIG. 2 shows a further longitudinal sectional view of the locking unit;

FIG. 3 shows a detailed view according to FIG. 1;

FIG. 4 shows a detailed view according to FIG. 2;

FIG. 5 shows a longitudinal sectional view of a locking unit according to a further embodiment;

FIG. 6 shows a longitudinal sectional view of a locking unit according to a further embodiment;

FIG. 7 shows a longitudinal sectional view of a locking unit according to a further embodiment;

FIG. 8 shows a shows a longitudinal sectional view of a locking unit according to a further embodiment;

FIG. 9 shows a longitudinal sectional view of a locking unit according to a further embodiment in a first position;

FIG. 10 shows a longitudinal sectional view of the locking unit according to FIG. 9 in a further position;

FIG. 11 shows a longitudinal sectional view of the locking unit according to FIG. 9 in a further position;

FIG. 12 shows a longitudinal sectional view of a locking unit according to the further embodiment;

FIG. 13 shows a longitudinal sectional view of a locking unit according to a further embodiment; and

FIG. 14 shows a sensor arrangement.

### DETAILED DESCRIPTION

In the figures, identical or mutually corresponding elements are denoted in each case by the same reference signs and will therefore not be described again unless expedient. In order to avoid repetitions, features that have already been described will not be described again, and such features are applicable to all elements with the same or mutually corresponding reference signs unless this is explicitly ruled out. The disclosures in the description as a whole are transferable analogously to identical parts with the same reference signs or the same component designations. It is also the case that the positional indications used in the description, such as for example above/top, below/bottom, lateral, etc., relate to the figure presently being described and illustrated and, in the case of the position being changed, are to be transferred analogously to the new position. Furthermore, it is also possible for individual features or combinations of features from the different exemplary embodiments shown and described to constitute independent or inventive solutions or solutions.

The locking unit can comprise a housing through which a longitudinal axis passes, a piston which is adjustable along the longitudinal axis between a retracted retraction position and an extended extension position, wherein the locking unit serves for locking the movement of the piston, which can be acted upon with the pressure of a fluid, wherein the locking unit has a solenoid and at least one latching element, wherein the piston has at least one first latching receptacle and one second latching receptacle, and the piston can be fixed by retaining interaction of the at least one latching element with one of the latching receptacles, wherein a guide element is fixedly connected to an armature or to an armature rod of the solenoid, which guide element is adjustable along the longitudinal axis between a blocking position and a release position and, depending on the position, pushes the at least one latching element radially outward.

The locking unit comprises a sensor unit which is formed from a permanent magnet, a multidirectional Hall sensor for detecting a magnetic field of the permanent magnet and a magnetic field changing means, wherein one of either the permanent magnet or the multidirectional Hall sensor is arranged in a fixed position with respect to the housing and the respective other of the permanent magnet and multidirectional Hall sensor is connected to the guide element so as to be adjustable along the longitudinal axis, wherein the piston penetrates an intermediate space between the permanent magnet and multidirectional Hall sensor, wherein that region of the piston which is adjustable through the intermediate space radially adjacently along the positionally fixed element of the permanent magnet and multidirectional Hall sensor defines a detection range, wherein the magnetic field changing means is arranged fixedly on the piston in the detection range such that different magnetic permeabilities are formed along the longitudinal axis in the detection range.

At least one inventive concept of this disclosure resides in a position-dependent disturbance or change in strength of the magnetic field detected by a single sensor. The locking unit therefore has only one single sensor for determining the position of the piston and for determining the position of the guide element. The piston is a separate part from the guide element. The one single sensor is the multidirectional Hall sensor. The advantage then resides in the fact that two components can be sensed independently of each other with one sensor or the multidirectional Hall sensor—dual sensing is carried out. For this purpose, the combinational action of two magnetic effects is utilized.

Firstly, the magnetic field of the permanent magnet acts on the multidirectional Hall sensor which detects said magnetic field and calculates a magnetic field angle of incidence therefrom. The multidirectional Hall sensor has at least two Hall elements which are arranged at an angle to one another, for example, at a right angle. The Hall elements therefore measure in different spatial directions and in each case generate a field curve, the field curves being used to calculate the magnetic field angle of incidence. All of the Hall elements of the multidirectional Hall sensor can be arranged in a single sensor housing. A cost-effective and space-saving design can thereby be created. The sensor housing can be a separate housing from the housing of the locking unit. A cost-effective and space-saving design can thereby also be created which can be produced separately and then can be mounted in the locking unit. The magnetic field angle of incidence provides information about the position of the permanent magnet relative to the multidirectional Hall sensor. By this first effect (magnetic field angle of incidence), a first component can be sensed, namely the position of the guide element. The permanent magnet can be arranged such that its magnetic field propagates in the radial direction, thus resulting in a favorable design with respect to the longitudinal axis and the adjustment direction of the piston.

Secondly, this magnetic field of the permanent magnet can be influenced in its strength by the magnetic field changing means, for example can be weakened or amplified with respect to another location in the detection range, as a result of which the multidirectional Hall sensor detects the correspondingly changed magnetic field. The magnetic field changing means which is adjustable with the piston can enter the magnetic field of the permanent magnet and can be arranged between the permanent magnet and the multidirectional Hall sensor such that the magnetic field which can be sensed is correspondingly changed. The magnetic field angle of incidence used with respect to the first effect can be without relevant influence on the magnetic field strength and therefore on the second effect, but the field strength of the magnetic field changes correspondingly. By this second effect (magnetic field strength), a second component can be sensed, for example the position of the piston.

Using such a locking unit, it is now possible with a multidirectional Hall sensor not only to lock the piston selectively in one of its two positions (retraction position and extension position), but also in a very simple way to obtain feedback as to whether locking of the guide element has also actually taken place since the position (blocking position and release position) is known.

The guide element is used in particular, depending on its position, to push the latching elements radially outward or else not to push them radially outward. If the guide element is appropriately positioned, locking is thereby achieved. By advantageous coupling of the permanent magnet to the guide element, the permanent magnet is in principle moved together with the guide element. The permanent magnet and guide element are immovable relative to each other. The location of the guide element via the permanent magnet can therefore be sensed by the multidirectional Hall sensor. In particular, it can be recognized with reference to the magnetic field angle of incidence in which location the permanent magnet is relative to the multidirectional Hall sensor, and it can be recognized with reference to the magnetic field strength whether the permanent magnet or the magnetic field thereof has been changed by the magnetic field changing means, from which it can be recognized in which location the magnetic field changing means or the piston is relative to the multidirectional Hall sensor.

The multidirectional Hall sensor can therefore determine, for example with respect to the piston, for example the states “piston retracted” (retraction position) and “piston extended” (extension position) and can therefore determine, with respect to the guide element, the states “latching elements blocked” (blocking position) and “latching elements released” (release position).

The locking unit can be trained in a two-stage process. In a first training stage, the first effect (magnetic field angle of incidence) is exclusively trained. In this case, the associated value of the magnetic field angle of incidence is detected in each position or in relevant positions of the permanent magnet relative to the multidirectional Hall sensor. A conclusion can then be drawn regarding the position of the permanent magnet with reference to the magnetic field angle of incidence. Advantageously, there is still no change in the magnetic field by the magnetic field changing means here. In a second training stage, the second effect (magnetic field strength) is then trained. The associated value of the magnetic field strength is detected here in each position or in relevant positions of the piston and therefore also the magnetic field changing means. A conclusion can then be drawn regarding the position of the piston with reference to the magnetic field strength. An evaluation unit which takes over the evaluation during operation can be trained. The evaluation unit can be connected by signal technology to the multidirectional Hall sensor. It is conceivable for the training to be undertaken with respect to temperature since a component temperature or temperature within the locking unit may have an effect on the magnetic field strength of the permanent magnet. The training can therefore be undertaken at a defined reference temperature.

The magnetic field of the permanent magnet crosses the wall of the piston. The magnetic field changing means serves for changing the magnetic field of the permanent magnet, for example by weakening or amplifying it. Weakening can be undertaken, for example, by measures having a magnetic insulation action. By contrast, amplification can be undertaken, for example, by measures which increase a magnetic permeability of the piston wall for the crossing magnetic field.

The magnetic field changing means has a magnetic permeability that differs from another region or a different location of the piston wall in the detection range such that different magnetic permeabilities are formed in the detection range along the longitudinal axis L. The magnetic field changing means may be designed and/or arranged in such a way that it itself has a magnetic permeability that differs from another location within the detection range, which has a different magnetic permeability from it. Different magnetic permeabilities are then formed in the detection range along the longitudinal axis, which lead to different magnetic field strengths. The magnetic field changing means changes the magnetic field of the permanent magnet compared to a location in the detection range where a magnetic field changing means does not change the magnetic field.

Advantageously, the magnetic permeability of the magnetic field changing means is such that an evaluably strong magnetic field can act on the multidirectional Hall sensor. This avoids “magnetically blind spots” at which the sensor does not detect a magnetic field and therefore cannot conclude where the components are located and/or cannot rule out a defect. In aspects, the magnetic permeability over the entire length of the detection range is such that an evaluably strong magnetic field can act on the multidirectional Hall sensor. Then the multidirectional Hall sensor can operate over the entire length of the detection range. This also avoids “magnetically blind spots”.

The two limits in the longitudinal direction of the detection range can be defined in each case via a straight line between the permanent magnet and the multidirectional Hall sensor in the respective end positions of the movable one of the two elements (permanent magnet and multidirectional Hall sensor) with respect to the positionally fixed one of the two elements. The limits may lie on said straight lines. Thus, in an advantageous manner, the detection range is only as large as necessary to achieve the advantageous effect, but only as small as possible to have constructive leeway with regard to other aspects that may be possibly negatively influenced by the criteria of the detection range.

The locking unit significantly reduces manufacturing costs and design complexity since it now only requires a single multidirectional Hall sensor for the detection of two independently moving components. In addition, the outlay on assembly and the potential sources of error during assembly and during operation are reduced.

The term “radial” and “longitudinal direction” should be understood in relation to the longitudinal axis.

According to a conceivable development of the locking unit, the permanent magnet or the multidirectional Hall sensor can be connected non-adjustably to the armature and/or to the armature rod and/or to the guide element via a connecting rod. By utilization of such a connecting rod, the distance between the permanent magnet or multidirectional Hall sensor and the solenoid can be of a sufficient size such that no effect on the magnetic field measurement should be expected.

According to a conceivable development of the locking unit, the permanent magnet or the multidirectional Hall sensor can be arranged within the piston. This has the advantage for the permanent magnet that there is no need to provide cabling there. The piston can guide the permanent magnet or the multidirectional Hall sensor radially, in particular by floating mounting. In particular, this can be advantageous in the embodiment with a connecting rod, since in this case the connecting rod can define the distance between the permanent magnet or the multidirectional Hall sensor and the guide element and thus the distance can be of such large size that the permanent magnet or multidirectional Hall sensor may be arranged in a region of the piston spaced apart from the guide element.

According to a conceivable development of the locking unit, a joint may be formed between the connecting rod, to which the permanent magnet can be fixedly connected, and the armature rod or in the connecting rod. Thus, a certain clearance can be provided, which is defined by the joint, such that, for example, when guiding the permanent magnet by the piston, no overdetermination of the system occurs. Any tolerances can be easily compensated by the joint without jamming or excessive abrasion occurring. Also in combination with the optional radial guide on the piston, the joint prevents the permanent magnet from grinding against the piston wall. Especially in the context of dual sensing, the joint is advantageous, because grinding and/or jamming of the permanent magnet against the piston could not only lead to incorrect conclusions about the position of the permanent magnet, but the permanent magnet would then be able to be jammed non-adjustably against the piston, and therefore incorrect conclusions about the position of the piston may also be drawn from this. The permanent magnet and the piston can be freely adjusted with respect to each other with the magnetic field changing means.

According to a conceivable development of the locking unit, the multidirectional Hall sensor can be arranged, for example, fixedly, on the housing. This has the advantage that the multidirectional Hall sensor is simply mounted and easily accessible for maintenance or replacement. In addition, this has the advantage that its cabling does not have to be routed into the depth of the housing, thus avoiding design complexity.

According to a conceivable development of the locking unit, it can have an evaluation unit, which can be coupled to the multidirectional Hall sensor and can be configured to determine a position of the guide element and the piston based on data of the multidirectional Hall sensor. Thus, it can be advantageously checked, for example, whether a locking has actually worked, with it being possible, for example, to check whether in terms of value a magnetic field angle of incidence and/or a magnetic field strength is above or below a threshold value.

According to a conceivable development of the locking unit, it can have a preload spring, which preloads the guide element into an end position. This end position can be the end position that the guide element occupies when the solenoid is not energized. The end position can be the blocking position of the guide element. This allows the guide element to be reset in a simple way when the solenoid is de-energized. The preload of the preload spring can either act directly on the guide element, wherein the preload spring is supported against the guide element, or can act indirectly on the guide element, wherein the preload spring is supported against a component which is arranged in between and which in turn is supported against the guide element or abuts it there. The component arranged in between can be an armature rod part, which is arranged on the armature rod.

According to a development of the locking unit, the magnetic field changing means can be formed in one piece from a piston wall or can be formed in a plurality of pieces with a piston wall. The first case is advantageous, since no separate component has to be provided as a magnetic field changing means. The magnetic field changing means can be formed, for example, in the production of the piston directly, for example by, for example, thickened and/or thinned regions of the piston wall with respect to a normal wall thickness of the piston. The second case is advantageous, since an identical piston can be used here for many different locking units (the same part reduces production and logistics costs), which piston can be provided with a corresponding magnetic field changing means depending on the application. The magnetic field changing means can namely be produced separately from the piston and then fixedly connected thereto.

According to a development of the locking unit, the magnetic field changing means can comprise a single changing element, which either has a consistent material thickness and/or consistent magnetic permeability along the longitudinal axis and extends only in a part of the detection range, or has an increasing material thickness and/or increasing magnetic permeability along the longitudinal axis, and in some aspects, increasing continuously. In the first case, the consistency serves for reliable detection of a position or a position range, in particular in the case of a stepped transition from the changing element to a directly adjacent region with differing magnetic permeability. The changing element can be arranged only in a part of the detection range, and therefore a region or a location with differing magnetic permeability can be provided in the detection range directly adjacent to the changing element, since the changing element is not arranged there. The length of the consistency in the longitudinal direction can define a position or a position range, because the magnetic field of the permanent magnet is changed identically at each position that remains the same. The first case represents an incremental detection. In the second case, the increase serves for an intermediate resolution, since the magnetic field of the permanent magnet is changed accordingly with the increase. Intermediate positions can then also be detected, since there is no incremental change here, but rather a sliding change in the magnetic field of the permanent magnet takes place.

According to a conceivable development of the locking unit, the magnetic field changing means can extend with increasing material thickness and/or increasing magnetic permeability in the longitudinal direction over the entire detection range. As a result, not only discrete positions can be sensed and evaluated in stages, but a stroke-proportional distance measurement can also be carried out by the then continuous magnetic field and thus signal influence. The resolution of the position measurement can therefore be increased. The resolution is then determined by the bit rate of the electronics, for example the evaluation unit, and not by the geometry of the locking unit and its components.

According to a conceivable development of the locking unit, the magnetic field changing means can increase steadily with increasing material thickness and/or increasing magnetic permeability, for example can be designed as a wedge. The continuity serves to change the magnetic field strength uniformly, since an adjustment of the armature in the longitudinal direction correlates with the change in the magnetic field strength. This also enables solid signal recognition.

According to a development of the locking unit, the magnetic field changing means can comprise a plurality of changing elements, each having a consistent material thickness along the longitudinal axis, wherein all of the changing elements can have or produce different thicknesses or material thicknesses and/or different magnetic permeabilities. Thus, each individual element of change has a dedicated and consistent material thickness and/or magnetic permeability. However, each individual changing element has a material thickness and/or magnetic permeability that differs from the other changing elements. A plurality of positions of the piston can then be clearly sensed according to the number of changing elements. The changing elements can be arranged adjacent to one another, either directly or else indirectly, in the longitudinal direction.

According to a development of the locking unit, the changing elements can be sorted along the longitudinal axis with respect to increasing material thickness and/or increasing magnetic permeability. This advantageously results in a graduation that allows incremental detection across a plurality of locations. Incremental graduation can be used to perform a plausibility check of data acquired by the multidirectional Hall sensor.

According to a development of the locking unit, a magnetic field passage can be formed between adjacent changing elements along the longitudinal axis. The respective magnetic field passage has a magnetic permeability that differs from the magnetic permeabilities of the two adjacent changing elements. The magnetic field passage allows the field lines of the magnetic field from the magnetic field changing means to pass unchanged to the multidirectional Hall sensor. This leads to what are referred to as peaks in the signal of the multidirectional Hall sensor, which are then used for the plausibility check, since adjacent changing elements can be distinguished very readily from one another.

According to a conceivable development of the locking unit, the respective magnetic field passage may have a higher or lower magnetic permeability than both adjacent changing elements. The signal peak is then clear and serves for operational reliability.

According to a conceivable development of the locking unit, the respective magnetic field passage can be formed in one piece from the piston wall or can be formed in a plurality of pieces with the piston wall. The first case is advantageous, since, for this purpose, no separate component has to be provided as a magnetic field passage. The magnetic field passage can be formed directly, for example, during the production of the piston. The second case is advantageous, since a piston of the same type can be used for many different locking units (the same part reduces production and logistics costs), which piston can be provided with a corresponding magnetic field passage depending on the application. The magnetic field passage can be produced separately from the piston and then fixedly connected thereto.

According to a conceivable development of the locking unit, the magnetic field passages, e.g., all of the magnetic field passages, can have identical magnetic permeabilities. This embodiment is also used for the plausibility check, as this does not confuse a measured value of the magnetic field that has passed through a changing element with a measured value of the magnetic field that has passed through a magnetic field passage. In aspects, the magnetic permeability of the magnetic field passages in the detection range is unique. Since the magnetic field passages then have their own permeability, it is not possible to confuse them with other components.

According to a conceivable development of the locking unit, the at least one changing element can be formed from a ferromagnetic element which is a separate component from the piston or is an integral portion of the piston. The separate embodiment allows a piston to be produced as an identical part and the changing element to be adapted to different requirements. The integral embodiment reduces the number of production steps, since arranging a separately produced changing element on the piston is dispensed with. In addition, there is no risk of unintentional detachment here.

According to a development of the locking unit, the at least one changing element can be formed from a film, a plate, a hollow cylinder, a coating (e.g., an electroplated coating), a recess (e.g., formed in the piston wall), or a permeability-changed region of the piston wall. It is conceivable that the at least one changing element consists of a ferromagnetic material or comprises such a material. This material has particularly good properties for changing the magnetic field. There are several possibilities for changing the magnetic permeability in the detection range.

A film, which may be a ferromagnetic film, can easily be realized in different magnetic permeabilities and can be easily arranged on the piston as a separately produced component.

For example, a plate, which may be a ferromagnetic plate, or a hollow cylinder, which may be a ferromagnetic hollow cylinder, as a separately produced component can be easily premanufactured and then mounted. It is also conceivable that the piston is at least in sections a plastics injection molding made of a thermoplastic and the plate/the hollow cylinder is designed as an insert of the injection molding.

A coating, which may be a ferromagnetic coating, has the advantage that it brings, on the one hand, the advantages of a separately produced component (identical part of the piston and application-specific adaptation), but, on the other hand, also realizes the advantages of an integral embodiment, since it is only formed directly on the piston. Electroplating of the piston in order to produce the at least one changing element has considerable advantages over separately produced components, since an electroplated layer does not become detached even during operation over the long term. This ensures a high level of operational reliability. Advantageously, the ferromagnetic coating may comprise nickel.

The recess may be a recess comprising a base. It is thus not continuous. This can give the piston stability. The recess may also be a continuous recess. It therefore opens toward the interior of the piston. The principle of the recess as a changing element is based on the concept that the magnetic field itself has to cross less material, which results in a change compared to a magnetic field which has to cross a thicker material that dissipates the magnetic field. The recess therefore produces a lower or higher magnetic permeability in the removed region. In a simple way, recesses can be formed in the piston wall itself, which is why no separately produced component is necessary for this purpose. These recesses can be provided directly during the production of the piston, for example in an injection mold, and/or also can be introduced retrospectively by removal of material only after the production of the piston. The material can be removed mechanically or by laser, resulting then in a mechanical recess or laser recess. Laser ablation especially is advantageous, since very small changing elements can be produced here. The at least one recess in combination with a film, a plate, a hollow cylinder, a coating (e.g., an electroplated coating), or a permeability-changed region of the piston wall can also define a changing element. Said elements may, for example, be formed or arranged in the recess such that combined effects result.

A permeability-changed region may be a portion of the piston wall that has been subsequently machined after production of the piston, in order to change the magnetic conductivity in this region relative to an unchanged region. It is conceivable, for example, that the permeability-changed region is a laser-irradiated region. This results in a chemical conversion in the irradiated region and in a change in the magnetic permeability. Laser hardening especially is advantageous since very small changing elements can be produced here. The advantage over material removal is that the sliding properties of the piston would not be affected by any wear-promoting steps and edges. It is also advantageous to avoid typical residues on the piston due to removal of material, such as grinding grooves. It is conceivable, for example, that the permeability-changed region is an etched region. Etching especially is advantageous since very small changing elements can also be produced here. Similarly, an advantage over removal of material is that the sliding properties of the piston would not be affected by any wear-promoting steps and edges. It is also advantageous to avoid typical residues on the piston due to removal of material, such as grinding grooves. In addition, etching is a cold process that requires less energy than laser irradiation.

Combinations of the above-mentioned embodiments of changing elements are also entirely conceivable, and therefore the magnetic field changing means can comprise different changing elements. This can lead to a reduction in costs and complexity.

According to a development of the locking unit, the multidirectional Hall sensor can comprise a temperature sensor and the locking unit can be designed to undertake temperature compensation of the sensor signals detected by the multidirectional Hall sensor using a temperature value detected by the temperature sensor. It is conceivable that a component temperature or temperature within the locking unit has an influence on the magnetic field strength of the permanent magnet; and can, for example, lower it. Therefore, at appropriate temperatures, a position of the piston that does not correspond to the real position and/or also does not correspond to the initially trained position could be mistakenly assumed. By utilizing the temperature compensation, the measured magnetic field strength can then be calculated with a temperature correction value in order thus to eliminate the temperature influence on the magnetic field strength.

According to a conceivable development of the locking unit, the piston can be magnetically permeable in the region of the detection range, e.g., in the entire detection range, and in some aspects, can be formed from a non-ferromagnetic material. This ensures that any alignment of permanent magnet to multidirectional Hall sensor can be sensed and there are no “magnetically blind spots” at which the magnetic field is isolated from the multidirectional Hall sensor and then cannot act on the multidirectional Hall sensor.

It is conceivable that the piston in the detection range is at least partially made of a thermoplastic, for example, as a plastics injection molding. Plastics, such as thermoplastics, are particularly suitable because as non-conductors they are permeable for solenoidal waves up to 100 GHz. ABS (acrylonitrile-butadiene-styrene copolymers) is a particularly suitable thermoplastic, as it is also additionally suitable for electroplating. It is therefore conceivable that the piston in the region of the detection range is designed as an ABS part and by presence of an electroplated coating is provided as a changing element for the formation of an electroformed product.

It is conceivable that the piston in the detection range is at least partially made of VA steel. VA steel or high-alloy steel is advantageously resistant to rust and acid on the one hand, but also is more non-magnetic in comparison to steels with fewer or no alloy additives, such as, for example, chrome. VA steel is therefore suitable as a construction material for components or sections of components that are less magnetic compared to components made of unalloyed steel or machining steel.

It is conceivable that the piston in the detection range is made of a ferromagnetic metal. In this case, irradiating processing by use of lasers can be carried out particularly easily, for example for laser hardening or laser ablation.

A combination of this is conceivable, namely that the piston in the detection range is made of a non-ferromagnetic and a ferromagnetic metal. Thus, the effect can be realized in a structurally simple manner. The ferromagnetic section shields the magnetic field of the permanent magnet considerably more strongly than the non-ferromagnetic section, which allows the magnetic field to pass through to the sensor unchanged.

According to a conceivable development of the locking unit, the piston in the detection range can be designed to be free from openings or closed. Therefore, at least in the detection range, no fluid exchange between the piston interior and the surroundings of the piston can take place. This results in outstanding sliding properties and enables fluidic separation, so that dirt particles in the fluid, which could distort the magnetic field of the permanent magnet and thus affect the signal quality, are separated. Especially in a conceivable application context, in which the locking unit can be installed surrounded by transmission oil, in which, for example, steel particles may be contained due to wear, this fluidic separation serves for the high signal quality even over a long service life.

According to a conceivable development of the locking unit, the multidirectional Hall sensor can be arranged at an opening of the housing, through which the piston protrudes. In these embodiments, the multidirectional Hall sensor and permanent magnet are positioned as close as possible to each other. This enables a relatively small permanent magnet to achieve a high field strength at the multidirectional Hall sensor.

According to a conceivable development of the locking unit, the piston can comprise a multi-part piston tube. The piston tube may comprise a first piston tube part, (e.g., formed of a ferromagnetic material), a second piston tube part (e.g., also formed of a non-ferromagnetic material), which is directly connected in the longitudinal direction to the first piston tube part, and a third piston tube part (e.g., formed of a non-ferromagnetic material), which is arranged circumferentially to the first and second piston tube parts and covers the join between the first and second piston tube parts. The third piston tube part can guide the piston in relation to the housing. Thus, the effect can be realized in a structurally simple manner. The ferromagnetic section shields the magnetic field of the permanent magnet considerably more strongly than the non-ferromagnetic section, which allows the magnetic field to pass through to the sensor unchanged.

According to the disclosure, a sensor unit is also proposed, which is formed from a permanent magnet, a multidirectional Hall sensor for detecting a magnetic field of the permanent magnet and a magnetic field changing means, wherein one of either the permanent magnet or the multidirectional Hall sensor is arranged or can be arranged in a fixed position and the respective other of the permanent magnet and multidirectional Hall sensor is adjustable along a first movement path, wherein the magnetic field changing means is adjustable along a second movement path in an intermediate space of the permanent magnet and multidirectional Hall sensor, wherein the magnetic field changing means defines at least two regions of different magnetic permeability in the intermediate space.

The advantages already described above with regard to the locking unit in the specific application context also result analogously for the sensor unit which is formulated without context and to which reference is hereby made. The embodiments mentioned above with regard to the locking unit apply without context, i.e., without reference to a locking unit, similarly also for the sensor unit. The two movement paths can advantageously be arranged parallel to each other in order to ensure a safe change in the magnetic field in each position of permanent magnet or multidirectional Hall sensor.

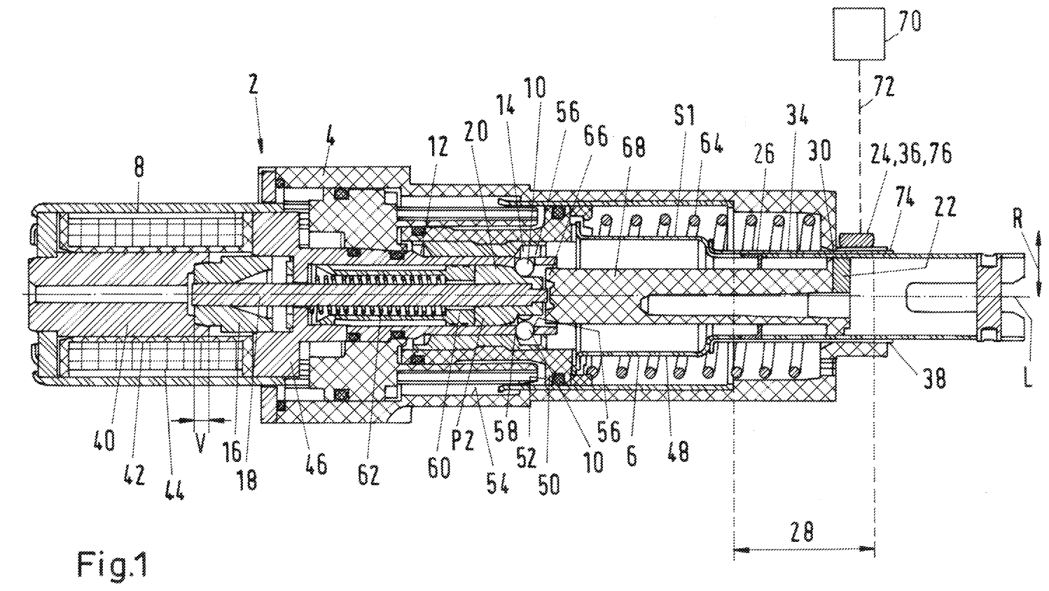

In FIGS. 1 to 4, a locking unit 2 is shown in two different states. The locking unit 2 comprises a housing 4, through which a longitudinal axis L passes, wherein a radial direction R protrudes with respect thereto. A longitudinal direction runs along the longitudinal axis L. The housing 4 has an opening 38 at one end and a solenoid 8 is connected at the other end.

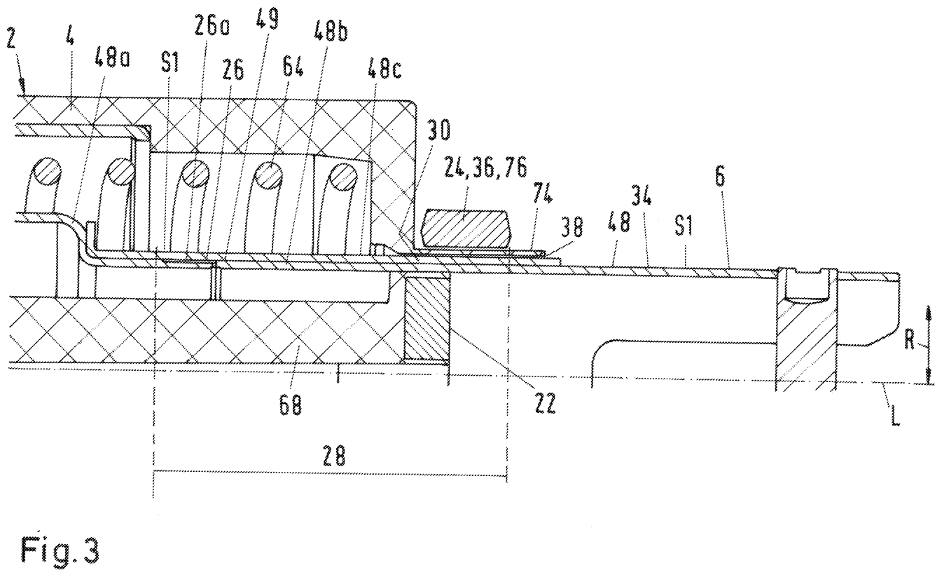

The solenoid 8 is shown energized in FIGS. 1 and 3 and comprises a core 40, a coil carrier 42, a coil 44 wound thereon, a yoke part 46, an armature 16 and an armature rod 18 fixedly connected thereto. Armature 16 and armature rod 18 are adjustable along the longitudinal axis L. In FIGS. 1 and 3, the armature 16 is tightened and therefore adjusted along the longitudinal axis L by the adjustment path V in the direction of core 40. A connecting rod 68 is connected to the armature rod 18 non-adjustably by a joint 66. The connecting rod 68 extends the armature rod 18 in the longitudinal direction toward the opening 38.

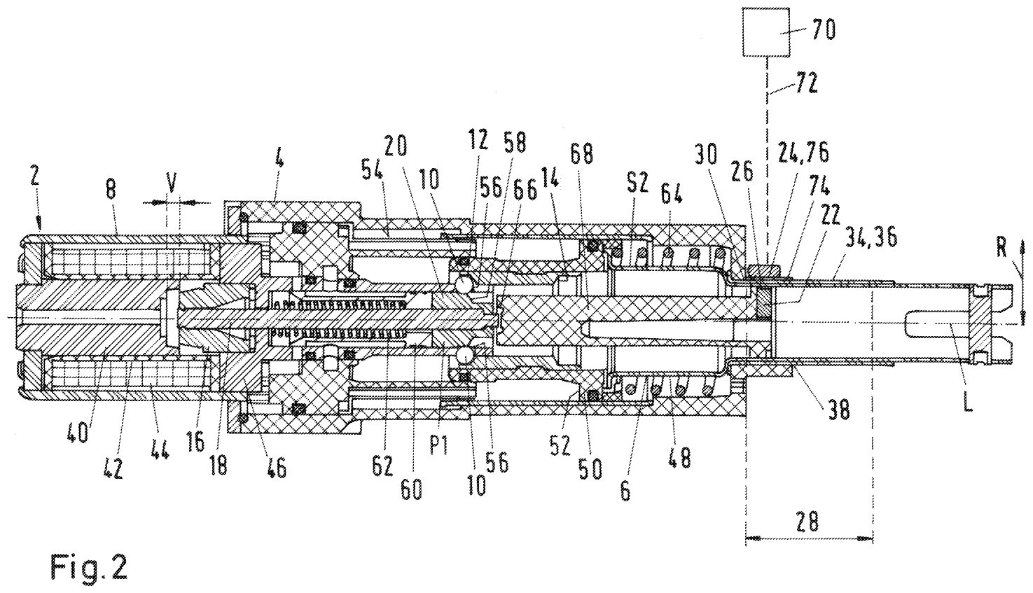

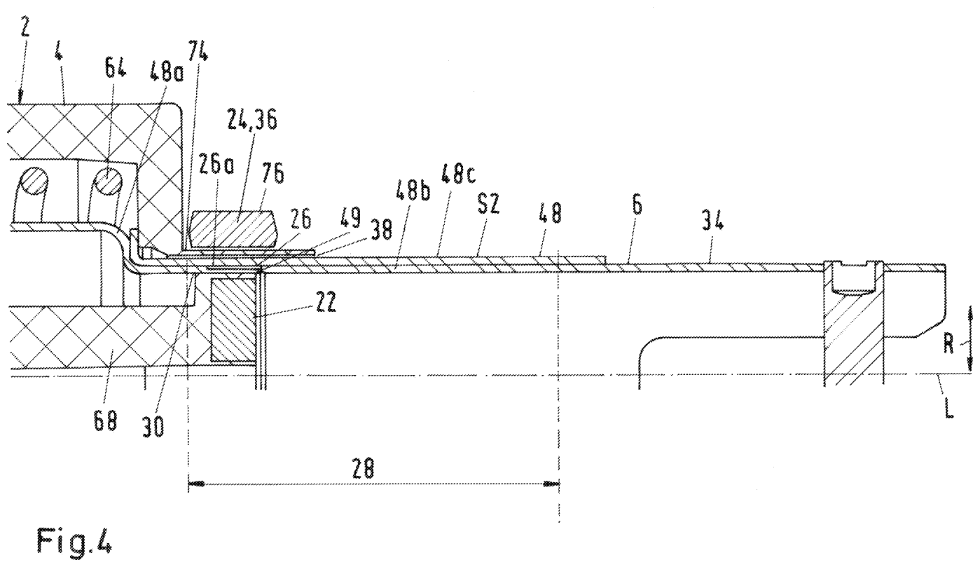

The locking unit 2 has a piston 6, which is adjustable along the longitudinal axis L between a retracted retraction position S1 (FIGS. 1 and 3) and an extended extension position S2 (FIGS. 2 and 4). In the locking unit 2 shown, the piston 6 comprises a plurality of parts, namely at least one piston tube 48 partially protruding from the opening 38 and a piston pressure piece 50. The piston pressure piece 50 is guided on the outer circumferential side. The piston pressure piece 50 has latching receptacles 12, 14 on its inner radial side, which are axially spaced apart from one another (with respect to the longitudinal axis L) and are in the form of annular bulges. The locking receptacles 12, 14 are arranged on the inner surface of the piston pressure piece 50 as a step or inner shoulder. The piston 6 also has a pressure surface 52 which is formed on the piston pressure piece 50 and delimits a pressure chamber 54, which can be filled with a fluid. The piston 6 can be moved from its retraction position S1 into its extension position S2 by pressure of the fluid in the pressure chamber 54. This fluid pressure shifts the piston 6 to the right in the plane of the image, i.e. further through the opening 38.

The locking unit 2 has a guide element 20, latching elements 10 and latching element bores 56. The guide element 20 is fixedly connected to the armature rod 18 and is therefore adjustable along the longitudinal axis L. Here, the guide element 20 is adjustable between a blocking position P1 (FIGS. 2 and 4) and a release position P2 (FIGS. 1 and 3). The latching element bores 56 are positionally fixed, here by way of example in the yoke part 46, and oriented in the radial direction R and are used to receive the latching elements 10. A latching element 10 is assigned to each latching element bore 56. The latching elements 10 are in the form of balls here. The guide element 20 has a conical surface 58, which presses the latching elements 10 in the radial direction R outward through the latching element bores 56 into the corresponding one of the latching receptacles 12, 14, depending on the position P1, P2. In FIGS. 1 and 3, however, the guide element 20 is moved into its release position P2, so that the latching elements 10 are not pushed outwardly radially through the conical surface 58 and therefore do not engage in any latching receptacle 12, 14, and thus the piston 6 is adjustable along the longitudinal axis L. By contrast, in FIGS. 2 and 4, the guide element 20 is moved into its blocking position P1, such that the latching elements 10 engage in a blocking manner in the respective latching receptacle 12 and consequently the piston 6 is fixed against an adjustment along the longitudinal axis L by the holding interaction of the latching elements 10 with the respective latching receptacle 12. The piston 6 is thus lockable in each position S1, S2, since, in the retraction position S1, the latching elements 10 can be pressed into the second latching receptacle 14 and, in the extension position S2, the latching elements 10 can be pressed into the first latching receptacle 12. An armature rod part 60 which abuts against the guide element 20 is arranged on the armature rod 18.

A preload spring 62, which may be designed as a helical compression spring, is supported between the yoke part 46 and the armature rod part 60. Alternatively, it could also be supported directly on the guide element 20. The preload spring 62 preloads the guide element 20 into an end position, which is defined here as the blocking position P1. From this blocking position P1, the guide element 20 can be moved into the release position P2 by energizing of the coil 44 and tightening of the armature 16 and longitudinal adjustment of the armature rod 18. The spring force of the preload spring 62 and the tensile force of the solenoid 8 are directed in opposite directions.

A piston compression spring 64, which may be designed as a helical compression spring, is supported between the piston 6 and the housing 4. It pushes the piston 6 to its retraction position S1. The spring force of the piston compression spring 64 and the compressive force of the fluid in the pressure chamber 54 are directed in opposite directions.

The solenoid 8 is shown in FIGS. 2 and 4 unenergized. As a result, the preload spring 62 presses the guide element 20 into its blocking position P1. The piston 6 is moved into its extension position S2 by fluid pressure. The latching elements 10 are pressed by the guide element 20 into the first latching receptacle 12. The extension position S2 of the piston is therefore secured.

The locking unit 2 also has a sensor unit which is formed from a permanent magnet 22, a multidirectional Hall sensor 24, which detects the magnetic field of the permanent magnet 22, and a magnetic field changing means 26 on the piston 6. The locking unit 2 may also comprise an evaluation unit 70, which can also form the sensor unit. The evaluation unit 70 can be connected by signal technology to the multidirectional Hall sensor 24 via a signal connection 72. The multidirectional Hall sensor 24 may comprise a temperature sensor 36, which can measure a component temperature or temperature within the locking unit 2. The multidirectional Hall sensor 24 has a plurality of Hall elements arranged within a single sensor housing 76.

The permanent magnet 22 is arranged within the piston 6 and generates a magnetic field which propagates outward in the radial direction R. The magnetic field of the permanent magnet 22 crosses the piston wall 34 of the piston 6. The permanent magnet 22 is arranged at one end on the connecting rod 68 opposite the solenoid 8. The connecting rod 68 extends in the piston 6. The permanent magnet 22 is therefore nonadjustable with respect to armature 16, armature rod 18, guide element 20 and connecting rod 68. By the advantageous coupling of the permanent magnet 22 to the guide element 20, the permanent magnet 22 moves with the guide element 20 in the same way. The permanent magnet 22 and the guide element 20 are therefore immovable relative to each other. The piston 6 guides the permanent magnet 22 and/or the connecting rod 68 radially by floating mounting.

The multidirectional Hall sensor 24 is arranged in an end-side flange 74 of the housing 4 in a positionally fixed manner and radially with respect to the permanent magnet 22 and the piston wall 34. It is therefore immovable relative to the housing 4. The multidirectional Hall sensor 24 is also located at the opening 38 of the housing 4. The magnetic field of the permanent magnet 22 acts on the multidirectional Hall sensor 24.

An intermediate space 30 is formed between the permanent magnet 22 and the multidirectional Hall sensor 24. This intermediate space 30 is penetrated by the piston 6 or its piston wall 34. That region of the piston 6 which is adjustable in the radial direction R adjacently along the positionally fixed multidirectional Hall sensor 24 through the intermediate space 30 defines a detection range 28 in the longitudinal direction. This detection range 28 is crossed by the magnetic field of the permanent magnet 22, irrespective of the position of the piston 6.

The magnetic field changing means 26 is arranged in this detection range 28 and fixedly on the piston 6. The magnetic field changing means 26 has a magnetic permeability that differs from a magnetic permeability in another region or at another location of the piston wall 34 in the detection range such that different magnetic permeabilities are formed in the detection range 28 along the longitudinal axis L.

The location of the permanent magnet 22 and thus of the guide element 20 can be determined via a magnetic field angle of incidence, which the multidirectional Hall sensor 24 can calculate from the sensed magnetic field. The location of the magnetic field changing means 26 and thus of the armature 6 can be determined by the magnetic field strength, which the multidirectional Hall sensor 24 can sense.

The piston tube 48 is constructed in multiple parts and comprises a first piston tube part 48a of a ferromagnetic material, a second piston tube part 48b of a non-ferromagnetic material, which is directly connected in the longitudinal direction to the first piston tube part 48a, and a third piston tube part 48c of a non-ferromagnetic material, which is arranged circumferentially to the piston tube parts 48a, 48b and covers the join 49 between the two piston tube parts 48a, 48b. The third piston tube part 48c guides the piston 6 in the opening 38 in relation to the housing 4. The first piston tube part 48a has, axially on the end side, a magnetic field changing means 26 in the form of a recess in the piston wall 34 and a changing element 26a arranged therein and produced separately from the piston wall 34.

The changing element 26a has a magnetic permeability, which differs from a magnetic permeability at another location in the detection range 28. Therefore, if the magnetic field of the permanent magnet 22 crosses the changing element 26a, the magnetic field is changed accordingly and the assigned position of the guide element 20 can be assumed. If there is no corresponding change in the magnetic field with respect to the multidirectional Hall sensor 24, this position of the guide element 20 cannot be assumed.

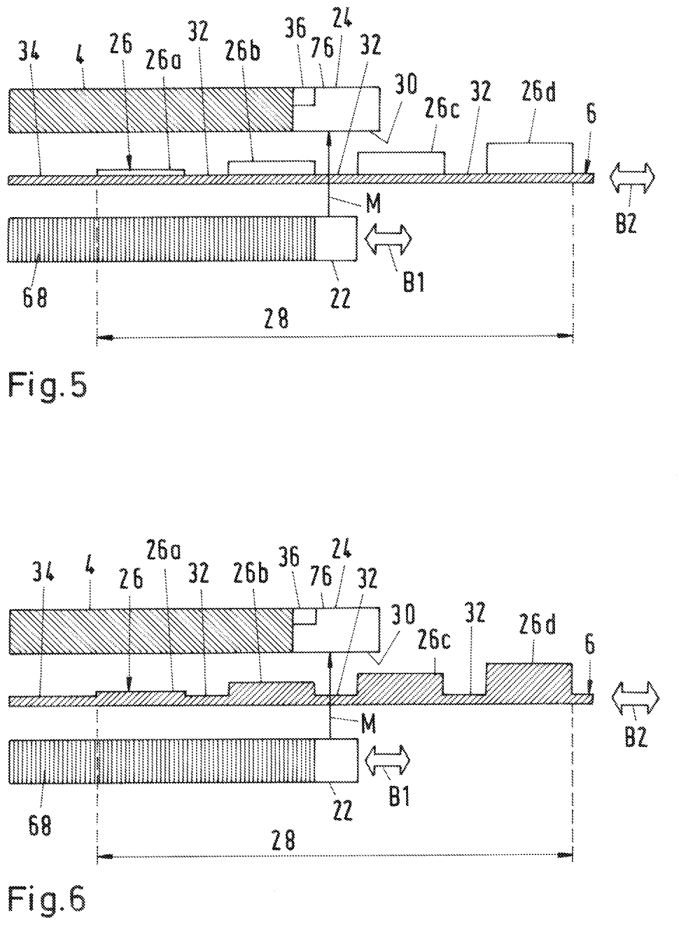

In the following, various embodiments of magnetic field changing means 26 will be described with respect to FIGS. 5 to 13. These embodiments or combinations thereof may well be used in the locking unit 2 of FIGS. 1 to 4 and should be considered as disclosed in combination therewith, unless technically contradictory.

FIG. 5 shows, in a longitudinal section, a magnetic field changing means 26 in the intermediate space 30, which is produced separately from the piston wall 34 and is fixedly connected to the piston 6. The magnetic field changing means 26 comprises a plurality of changing elements 26a, 26b, 26c, 26d, each having a constant material thickness along the longitudinal axis L and being indirectly adjacent to one another in the longitudinal direction. The changing elements 26a, 26b, 26c, 26d extend only in parts of the detection range 28. However, it can be seen that all of the changing elements 26a, 26b, 26c, 26d are made of different material thicknesses and/or of differently magnetically permeable materials. Since four changing elements 26a, 26b, 26c, 26d are provided here, four different positions of the piston 6 can be sensed, depending on which of the four changing elements 26a, 26b, 26c, 26d changes the magnetic field in front of the multidirectional Hall sensor 24. The changing elements 26a, 26b, 26c, 26d are sorted along the longitudinal axis L with respect to increasing material thickness and/or increasing magnetic permeability. It is also evident that a respective magnetic field passage 32 is formed between adjacent changing elements 26a, 26b, 26c, 26d along the longitudinal axis L. The magnetic field passages 32 are formed in one piece from the piston wall 34 and have a higher or lower magnetic permeability than the two adjacent changing elements 26a, 26b, 26c, 26d. The magnetic field passages 32 all have identical magnetic permeabilities. The changing elements 26a, 26b, 26c, 26d can be formed, for example, from a film, a plate, a hollow cylinder or a coating. The piston 6 is magnetically permeable throughout the detection range 28. In the state shown, the magnetic field of the permanent magnet 22 crosses one of the magnetic field passages 32 along the magnetic arrow M. The permanent magnet 22 can be located, the magnetic field changing means 26 cannot be located, since it is not crossed from the magnetic field of the permanent magnet 22 to the multidirectional Hall sensor 24. The permanent magnet 22 is adjustable along a first movement path B1 along the longitudinal axis L. The magnetic field changing means 26 is adjustable along a second movement path B2 along the longitudinal axis L.

FIG. 6 shows, in a longitudinal section, a magnetic field changing means 26, which is formed in one piece from the piston wall 34. The magnetic field changing means 26 comprises a plurality of changing elements 26a, 26b, 26c, 26d, each having a constant material thickness along the longitudinal axis L and being indirectly adjacent to one another in the longitudinal direction. The changing elements 26a, 26b, 26c, 26d extend only in parts of the detection range 28. However, it can be seen that all of the changing elements 26a, 26b, 26c, 26d are made of different material thicknesses and/or of differently magnetically permeable materials. Since four changing elements 26a, 26b, 26c, 26d are provided here, four different positions of the piston 6 can be sensed, depending on which of the four changing elements 26a, 26b, 26c, 26d changes the magnetic field in front of the multidirectional Hall sensor 24. The changing elements 26a, 26b, 26c, 26d are sorted along the longitudinal axis L with respect to increasing material thickness and/or increasing magnetic permeability. It is also evident that a respective magnetic field passage 32 is formed between adjacent changing elements 26a, 26b, 26c, 26d along the longitudinal axis L. The magnetic field passages 32 are formed in one piece from the piston wall 34 and have a higher or lower magnetic permeability than the two adjacent changing elements 26a, 26b, 26c, 26d. The magnetic field passages 32 all have identical magnetic permeabilities. The piston 6 is magnetically permeable throughout the detection range 28. In the state shown, the magnetic field of the permanent magnet 22 crosses one of the magnetic field passages 32 along the magnetic arrow M. The permanent magnet 22 can be located, the magnetic field changing means 26 cannot be located, since it is not crossed from the magnetic field of the permanent magnet 22 to the multidirectional Hall sensor 24. The permanent magnet 22 is adjustable along a first movement path B1 along the longitudinal axis L. The magnetic field changing means 26 is adjustable along a second movement path B2 along the longitudinal axis L.

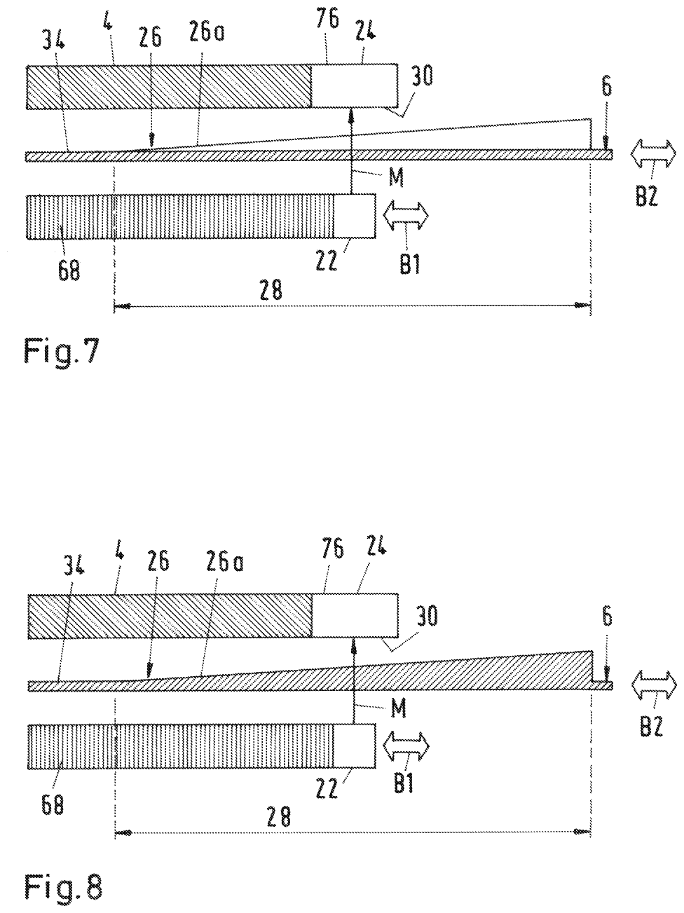

FIG. 7 shows, in a longitudinal section, a magnetic field changing means 26 in the intermediate space 30, which is produced separately from the piston wall 34, is fixedly connected to the piston 6 and has an increasing material thickness and/or increasing magnetic permeability along the longitudinal axis L. The magnetic field changing means 26 comprises a single changing element 26a, which is designed as a wedge. The magnetic field changing means 26 with increasing material thickness and/or increasing magnetic permeability extends along the longitudinal axis L over the entire detection range 28. Since the magnetic permeability changes along the longitudinal axis L, any position of the piston 6 can be sensed here. The separately produced single changing element 26a can be formed, for example, from a film, a plate, a hollow cylinder or a coating. The piston 6 is magnetically permeable throughout the detection range 28. In the state shown, the magnetic field of the permanent magnet 22 crosses the changing element 26a along the magnetic arrow M. The permanent magnet 22 and the magnetic field changing means 26 can be located. The permanent magnet 22 is adjustable along a first movement path B1 along the longitudinal axis L. The magnetic field changing means 26 is adjustable along a second movement path B2 along the longitudinal axis L.

FIG. 8 shows, in a longitudinal section, a magnetic field changing means 26, which is formed in one piece from the piston wall 34 and has an increasing material thickness and/or increasing magnetic permeability along the longitudinal axis L. The magnetic field changing means 26 comprises a single changing element 26a, which is designed as a wedge. The magnetic field changing means 26 with increasing material thickness and/or increasing magnetic permeability extends along the longitudinal axis L over the entire detection range 28. Since the magnetic permeability changes along the longitudinal axis L, any position of the piston 6 can be sensed here. The piston 6 is magnetically permeable throughout the detection range 28. In the state shown, the magnetic field of the permanent magnet 22 crosses the changing element 26a along the magnetic arrow M. The permanent magnet 22 and the magnetic field changing means 26 can be located. The permanent magnet 22 is adjustable along a first movement path B1 along the longitudinal axis L. The magnetic field changing means 26 is adjustable along a second movement path B2 along the longitudinal axis L.

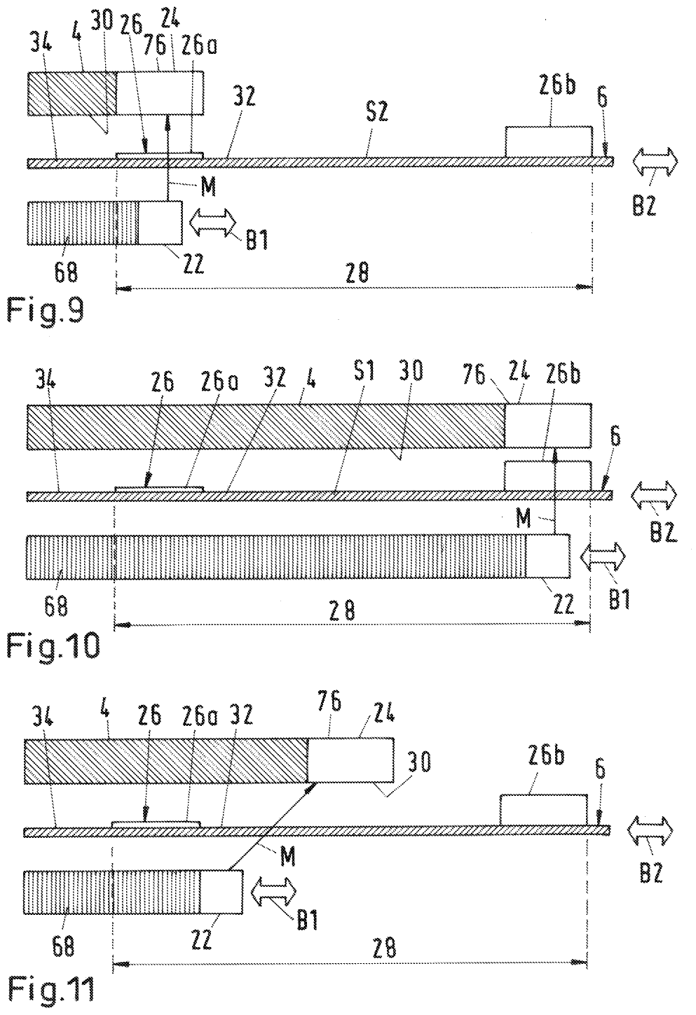

FIGS. 9 to 11 show different states of an embodiment. FIGS. 9 to 11 show, in in each case a longitudinal section, a magnetic field changing means 26 in the intermediate space 30, which is produced separately from the piston wall 34 and is fixedly connected to the piston 6. The magnetic field changing means 26 comprises two changing elements 26a, 26b, each having a constant material thickness along the longitudinal axis L and being indirectly adjacent to one another in the longitudinal direction. The changing elements 26a, 26b extend only in parts of the detection range 28. A changing element 26a is assigned to the extension position S2 of the piston 6 and a changing element 26b is assigned to the retraction position S1 of the piston 6. It can be seen that all of the changing elements 26a, 26b are made of different material thicknesses and/or of differently magnetically permeable materials. Since two changing elements 26a, 26b are provided here, two different positions of the piston 6 can be sensed, depending on which of the two changing elements 26a, 26b changes the magnetic field in front of the multidirectional Hall sensor 24. It can be seen that a magnetic field passage 32 is formed between adjacent changing elements 26a, 26b along the longitudinal axis L. The magnetic field passage 32 is formed in one piece from the piston wall 34 and has a higher or lower magnetic permeability than the two adjacent changing elements 26a, 26b. The separately produced changing elements 26a, 26b can be formed, for example, from a film, a plate, a hollow cylinder or a coating. The piston 6 is magnetically permeable throughout the detection range 28. The permanent magnet 22 is adjustable along a first movement path B1 along the longitudinal axis L. The magnetic field changing means 26 is adjustable along a second movement path B2 along the longitudinal axis L.

In the state shown in FIG. 9, the magnetic field of the permanent magnet 22 crosses the changing element 26a along the magnetic arrow M. The changing element 26a therefore changes the magnetic field, which can be sensed by the multidirectional Hall sensor 24, in relation to another location of the detection range 28, for example in relation to the magnetic field passage 32. The magnetic field angle of incidence can be calculated from the magnetic field, wherein the position P1 of the guide element 20 can be assigned to a magnetic field angle of incidence and the position P2 of the guide element 20 can be assigned to another magnetic field angle of incidence. The release position P2 is sensed here. With reference to the magnetic field strength, which is assigned to a position of the piston 6, the position of the piston 6 can be detected; with regard to FIG. 9, the extension position S2 is sensed. The piston 6 is therefore released in its extension position S2.

In the state shown in FIG. 10, the magnetic field of the permanent magnet 22 now crosses the changing element 26b along the magnetic arrow M. The changing element 26b therefore changes the magnetic field, which can be sensed by the multidirectional Hall sensor 24, in relation to another location of the detection range 28, for example in relation to the magnetic field passage 32. Here too, the magnetic field angle of incidence for determining the position of the guide element 20 can be calculated from the magnetic field. The blocking position P1 is sensed here. With reference to the magnetic field strength, which is assigned to a position of the piston 6, the position of the piston 6 can be detected; with regard to FIG. 10, the retraction position S1 is sensed. The piston 6 is therefore blocked in its retraction position S1.

In the state shown in FIG. 11, the magnetic field of the permanent magnet 22 crosses the magnetic field passage 32 along the magnetic arrow M. No changing element 26a, 26b therefore changes the magnetic field which can be sensed by the multidirectional Hall sensor 24. From the magnetic field, the angle of incidence of the magnetic field can thus be calculated, to which a position P1, P2 or intermediate position of the guide element 20 is/can be assigned. With reference to the magnetic field strength, the position of the piston 6 cannot be detected, since no changing element 26a, 26b enters in a changing manner into the magnetic field, which can be sensed, in front of the multidirectional Hall sensor 24. The multidirectional Hall sensor 24 thus, when crossing the magnetic field along the magnetic arrow M between the two changing elements 26a, 26b, cannot sense in which location the piston 6 is located. The position of the piston 6 is unknown.

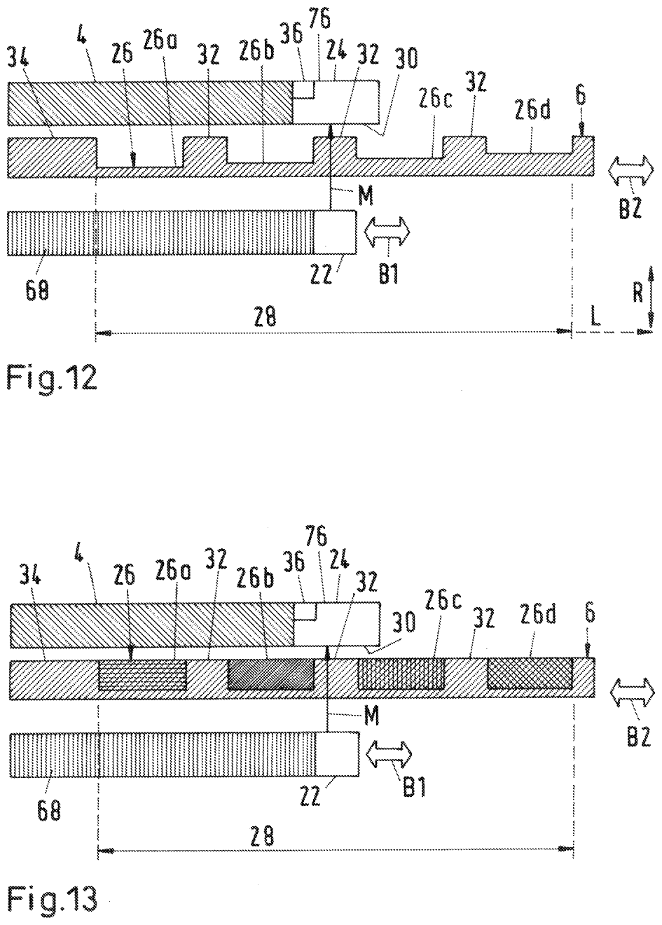

FIG. 12 shows, in a longitudinal section, a magnetic field changing means 26, which is formed in one piece from the piston wall 34. The magnetic field changing means 26 comprises a plurality of changing elements 26a, 26b, 26c, 26d, each having a constant thickness along the longitudinal axis L and being indirectly adjacent to one another in the longitudinal direction. The changing elements 26a, 26b, 26c, 26d extend only in parts of the detection range 28. However, it can be seen that all of the changing elements 26a, 26b, 26c, 26d have different thicknesses and also lead here to different material thicknesses of the piston wall 34 in the radial direction R adjacent to the respective changing element 26a, 26b, 26c, 26d. Since four changing elements 26a, 26b, 26c, 26d are provided here, four different positions of the piston 6 can be sensed, depending on which of the four changing elements 26a, 26b, 26c, 26d changes the magnetic field in front of the multidirectional Hall sensor 24. The changing elements 26a, 26b, 26c, 26d are sorted along the longitudinal axis L with respect to increasing material thickness and/or increasing magnetic permeability. It is also evident that a respective magnetic field passage 32 is formed between adjacent changing elements 26a, 26b, 26c, 26d along the longitudinal axis L. The magnetic field passages 32 are formed in one piece from the piston wall 34 and have a higher or lower magnetic permeability than the two adjacent changing elements 26a, 26b, 26c, 26d. The magnetic field passages 32 all have identical magnetic permeabilities. The changing elements 26a, 26b, 26c, 26d are each formed from a recess of the piston wall 34. The piston 6 is magnetically permeable throughout the detection range 28. In the state shown, the magnetic field of the permanent magnet 22 crosses one of the magnetic field passages 32 along the magnetic arrow M. The permanent magnet 22 can be located, the magnetic field changing means 26 cannot be located, since it is not crossed from the magnetic field of the permanent magnet 22 to the multidirectional Hall sensor 24. The permanent magnet 22 is adjustable along a first movement path B1 along the longitudinal axis L. The magnetic field changing means 26 is adjustable along a second movement path B2 along the longitudinal axis L.

FIG. 13 shows, in a longitudinal section, a magnetic field changing means 26. The magnetic field changing means 26 comprises a plurality of changing elements 26a, 26b, 26c, 26d, each being indirectly adjacent to one another in the longitudinal direction. The changing elements 26a, 26b, 26c, 26d each have a constant material thickness along the longitudinal axis L, wherein all of the changing elements 26a, 26b, 26c, 26d have different magnetic permeabilities. The changing elements 26a, 26b, 26c, 26d extend only in parts of the detection range 28. Since four changing elements 26a, 26b, 26c, 26d are provided here, four different positions of the piston 6 can be sensed, depending on which of the four changing elements 26a, 26b, 26c, 26d changes the magnetic field in front of the multidirectional Hall sensor 24. The changing elements 26a, 26b, 26c, 26d are sorted along the longitudinal axis L with respect to increasing magnetic permeability. It is also evident that a respective magnetic field passage 32 is formed between adjacent changing elements 26a, 26b, 26c, 26d along the longitudinal axis L. The magnetic field passages 32 are formed in one piece from the piston wall 34 and have a higher or lower magnetic permeability than the two adjacent changing elements 26a, 26b, 26c, 26d. The magnetic field passages 32 all have identical magnetic permeabilities. The changing elements 26a, 26b, 26c, 26d are each formed from a magnetically permeability-changed region of the piston wall 34. The piston 6 is magnetically permeable throughout the detection range 28. In the state shown, the magnetic field of the permanent magnet 22 crosses one of the magnetic field passages 32 along the magnetic arrow M. The permanent magnet 22 can be located, the magnetic field changing means 26 cannot be located, since it is not crossed from the magnetic field of the permanent magnet 22 to the multidirectional Hall sensor 24. The permanent magnet 22 is adjustable along a first movement path B1 along the longitudinal axis L. The magnetic field changing means 26 is adjustable along a second movement path B2 along the longitudinal axis L.

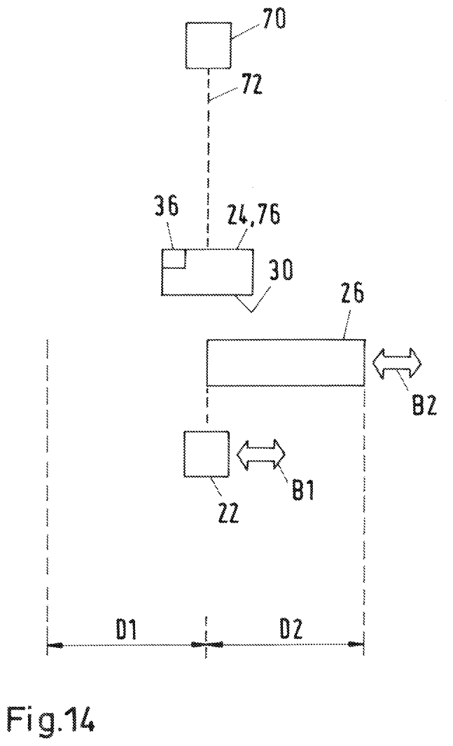

FIG. 14 shows a sensor unit which is free from application context and which is formed from a permanent magnet 22, a multidirectional Hall sensor 24 for detecting a magnetic field of the permanent magnet 22 and a magnetic field changing means 26, wherein the multidirectional Hall sensor 24 is arranged or can be arranged in a positionally fixed manner and the permanent magnet 22 is adjustable along the first movement path B1. The magnetic field changing means 26 is adjustable in the intermediate space 30 of permanent magnet 22 and multidirectional Hall sensor 24 along a second movement path B2, wherein the magnetic field changing means 26 defines at least two permeability ranges D1, D2 of different magnetic permeability in the intermediate space 30. The movement paths B1, B2 are arranged parallel to each other. The magnetic field changing means 26 can be configured as mentioned above.

The invention is not restricted to one of the embodiments described above, but may be modified in a variety of ways. All the features and advantages that emerge from the claims, the description and the drawing, including structural details, spatial arrangements and method steps, may be essential to the invention both individually and in a wide variety of combinations.

The invention encompasses all combinations of at least two of the features disclosed in the description, the claims and/or the figures.

To avoid repetitions, it is the intention that features disclosed in device terms are also disclosed, and capable of being claimed, in method terms. It is likewise the intention that features disclosed in method terms are disclosed, and capable of being claimed, in device terms.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

### LIST OF REFERENCE NUMERALS

2 locking unit
4 housing
6 piston
8 solenoid
10 latching element
12 first latching receptacle
14 second latching receptacle
16 armature
18 armature rod
20 guide element
22 permanent magnet
24 multidirectional Hall sensor
26 magnetic field changing means
26a-26d changing element
28 detection range
30 intermediate space
32 magnetic field passage
34 piston wall
36 temperature sensor
38 opening
40 core
42 coil carrier
44 coil
46 yoke part
48 piston tube
48a first piston tube part
48b second piston tube part
48c third piston tube part
49 join
50 piston pressure piece
52 pressure surface
54 pressure chamber
56 latching element bore
58 conical surface
60 armature rod part
62 preload spring
64 piston pressure spring
66 joint
68 connecting rod
70 evaluation unit
72 signal connection
74 flange
76 sensor housing
B1 first movement path
B2 second movement path
D1 permeability range
D2 permeability range
L longitudinal axis
M magnetic arrow
P1 blocking position
P2 release position
R radial direction
S1 retraction position
S2 extension position
V adjustment path

What is claimed is:

1. A locking unit comprising:
a housing through which a longitudinal axis passes;
a piston which is adjustable along the longitudinal axis between a retracted retraction position and an extended extension position, wherein the locking unit serves for locking a movement of the piston, which can be acted upon with a pressure of a fluid, wherein the piston has a first latching receptacle and a second latching receptacle;
a solenoid having an armature and an armature rod connected to the armature;
at least one latching element, wherein the piston is fixed by retaining interaction of the at least one latching element with one of the first latching receptacle and the second latching receptacle of the piston;
a guide element fixedly connected to the armature or to the armature rod of the solenoid, wherein the guide element is adjustable along the longitudinal axis of the housing between a blocking position and a release position, wherein, depending on the position, the guide element pushes the at least one latching element radially outward; and
a sensor unit comprising a permanent magnet, a multidirectional Hall sensor for detecting a magnetic field of the permanent magnet and a magnetic field changing means, wherein one of either the permanent magnet or the multidirectional Hall sensor is arranged in a fixed position with respect to the housing and the respective other of the permanent magnet and multidirectional Hall sensor is connected to the guide element so as to be adjustable along the longitudinal axis,
wherein the piston penetrates an intermediate space between the permanent magnet and multidirectional Hall sensor,
wherein a region of the piston, which is adjustable through the intermediate space radially adjacently along the positionally fixed element of the permanent magnet and multidirectional Hall sensor, defines a detection range,
wherein the magnetic field changing means is arranged fixedly on the piston in the detection range such that different magnetic permeabilities are formed along the longitudinal axis in the detection range.

2. The locking unit as claimed in claim 1, wherein the magnetic field changing means is formed in one piece from a piston wall of the piston.

3. The locking unit as claimed in claim 1, wherein the magnetic field changing means is formed in multiple pieces with a piston wall of the piston.

4. The locking unit as claimed in claim 1, wherein the magnetic field changing means comprises a single changing element that extends only in part of the detection range.

5. The locking unit as claimed in claim 4, wherein the single changing element has a consistent material thickness, a consistent magnetic permeability along the longitudinal axis, or both a consistent material thickness and a consistent magnetic permeability along the longitudinal axis.

6. The locking unit as claimed in claim 1, wherein the magnetic field changing means comprises a single changing element that has an increasing material thickness, an increasing magnetic permeability along the longitudinal axis, or both an increasing material thickness and an increasing magnetic permeability along the longitudinal axis.

7. The locking unit as claimed in claim 6, wherein the increasing material thickness increases continuously.

8. The locking unit as claimed in claim 6, wherein the increasing magnetic permeability increases continuously.

9. The locking unit as claimed in claim 1, wherein the magnetic field changing means comprises a plurality of changing elements which each have a consistent material thickness along the longitudinal axis.

10. The locking unit as claimed in claim 9, wherein the plurality of changing elements have or produce different thicknesses, have or produce different material thicknesses, have or product different magnetic permeabilities, or combinations thereof.

11. The locking unit as claimed in claim 9, wherein the plurality of changing elements are sorted along the longitudinal axis with respect to increasing material thickness.

12. The locking unit as claimed in claim 11, wherein the plurality of changing elements are sorted along the longitudinal axis with respect to increasing magnetic permeability.

13. The locking unit as claimed in claim 9, wherein the plurality of changing elements are sorted along the longitudinal axis with respect to increasing magnetic permeability.

14. The locking unit as claimed in claim 9, wherein a respective magnetic field passage is formed between the plurality of changing elements which are adjacent along the longitudinal axis.

15. The locking unit as claimed in claim 9, wherein the plurality of changing elements is formed from a film, a plate, a hollow cylinder, a coating, a recess, or a permeability-changed region of a piston wall of the piston.

16. The locking unit as claimed in claim 15, herein the coating is an electroplated coating.

17. The locking unit as claimed in claim 1, wherein the multidirectional Hall sensor comprises a temperature sensor and the locking unit is configured to undertake temperature compensation of sensor signals detected by the multidirectional Hall sensor using a temperature value detected by the temperature sensor.

18. A sensor unit comprising:
a permanent magnet;
a multidirectional Hall sensor for detecting a magnetic field of the permanent magnet; and
a magnetic field changing means comprises a plurality of changing elements,
wherein one of either the permanent magnet or the multidirectional Hall sensor is arranged in a fixed position, wherein the respective other of the permanent magnet and multidirectional Hall sensor is adjustable along a first movement path, wherein the magnetic field changing means is adjustable along a second movement path in an intermediate space of the permanent magnet and multidirectional Hall sensor, wherein the plurality of changing elements defines at least two regions of different magnetic permeability in the intermediate space.
